(19) United States
(12) Patent Application Publication
(10) Pub. No.: US 2011/0117427 A1
(43) Pub. Date: May 19, 2011

(54) BATTERIES

(75) Inventors: Chih-Yen Lin, Taoyuan County (TW); Ping-Sung Hung, Taoyuan County (TW); Yeong-Cherng Chiou, Taoyuan County (TW); Chiang-Wen Lai, Taoyuan County (TW)

(73) Assignee: NAN YA PCB CORP., Taoyuan County (TW)

(21) Appl. No.: 12/639,806

(22) Filed: Dec. 16, 2009

(30) Foreign Application Priority Data
Nov. 18, 2009 (TW) TW98139090

(51) Int. Cl. H01M 2/08

(52) U.S. Cl. 429/185

(57) ABSTRACT

A battery. A electrode plate assembly is disposed in a casing and includes at least one current collection tab. At least one conductive primer is fit in the current collection tab of the electrode plate assembly and includes an inner threaded portion. At least one sealing cover is connected to the casing. At least one metal washer is disposed between the conductive primer and the sealing cover. At least one first insulation washer is fit on the sealing cover. At least one hollow conductive terminal is riveted to the first insulation washer and metal washer. At least one bolt is fastened to the inner threaded portion of the conductive primer via the hollow conductive terminal, first insulation washer, sealing cover, and metal washer and abuts the hollow conductive terminal. A laser welding treatment is applied between the bolt and the hollow conductive terminal, providing a sealing effect therebetween.

### CROSS REFERENCE TO RELATED APPLICATIONS

This Application claims priority of Taiwan Patent Application No. 098139090, filed on Nov. 18, 2009, the entirety of which is incorporated by reference herein.

### BACKGROUND OF THE INVENTION

1. Field of the Invention

The invention relates to batteries, and more particularly to batteries preventing electrolyte leakage and providing reduced impedance.

2. Description of the Related Art

In a rechargeable battery (such as, a lithium battery, a nickel-metal hydride battery, etc.), a positive electrode plate and a negative electrode plate are wound around a core and multiple current collection tabs thereof serve as output ends. Here, multiple separators separate the positive electrode plate from the negative electrode plate to avoid short circuit, and electrolyte is filled in the rechargeable battery.

Referring to FIG. 1A and FIG. 1B, a conventional rechargeable battery 1 comprises a casing 10, a electrode plate assembly 30, two conductive primers 40, two conductive terminals 50, two first insulation washers 61, two sealing covers 70, two second insulation washers 62, and two nuts 80.

The electrode plate assembly 30 is disposed in the casing 10 and comprises a positive electrode plate (not shown), a negative electrode plate (not shown), a plurality of separators (not shown), a plurality of positive current collection tabs 31, a plurality of negative current collection tabs 32, and a core 33. Here, the separators are disposed between the positive electrode plate and the negative electrode plate, the positive current collection tabs 31 are connected to the positive electrode plate, and the negative current collection tabs 32 are connected to the negative electrode plate. Additionally, the positive electrode plate, negative electrode plate, and separators are simultaneously wound around the core 33, and the casing 10 is filled with electrolyte (not shown).

The conductive primers 40 are respectively fit in the positive current collection tabs 31 and negative current collection tabs 32.

Each conductive terminal 50 is fit on each conductive primer 40 and comprises an outer threaded portion 51.

Each first insulation washer 61 is fit on each conductive terminal 50.

Each sealing cover 70 is fit on each first insulation washer 61 and each conductive terminal 50 and is connected to the casing 10. Here, the sealing covers 70 respectively surround and connect to the circumferences of two ends of the casing 10.

Each second insulation washers 62 is fit on each sealing cover 70 and each conductive terminal 50.

Each nut 80 is fastened to the outer threaded portion 51 of each conductive terminal 50, tightly fixing each conductive terminal 50, each first insulation washer 61, each sealing cover 70, and each second insulation washer 62, and thereby preventing the electrolyte from leaking out of the casing 10.

Moreover, power output can be achieved using the conductive terminals 50.

The rechargeable battery 1 has the following drawbacks. Because a sealing effect of the casing 10 or rechargeable battery 1 is achieved by the nuts 80 fastened to the conductive terminals 50, the electrolyte may leak out of the casing 10 when fastening between the nuts 80 and the conductive terminals 50 is loosened, causing damage to the rechargeable battery 1 or other devices applying the rechargeable battery 1. Additionally, when the fastening between the nuts 80 and the conductive terminals 50 is loosened due to vibration, a poor abutting effect is generated between the conductive terminals 50 and the conductive primers 40. Thus, increased internal contact impedance occurs in the rechargeable battery 1, reducing the power output performance of the rechargeable battery 1. In another aspect, when the fastening between the nuts 80 and the conductive terminals 50 is excessively tight, the first insulation washers 61 and second insulation washers 62 are easily deformed and distorted, thereby causing leakage of the electrolyte in the casing 10.

### BRIEF SUMMARY OF THE INVENTION

A detailed description is given in the following embodiments with reference to the accompanying drawings.

An exemplary embodiment of the invention provides a battery comprising a casing, a electrode plate assembly, at least one conductive primer, at least one sealing cover, at least one metal washer, at least one first insulation washer, at least one hollow conductive terminal, and at least one bolt. The electrode plate assembly is disposed in the casing and comprises at least one current collection tab. The conductive primer is fit in the current collection tab of the electrode plate assembly and comprises an inner threaded portion. The sealing cover is connected to the casing. The metal washer is disposed between the conductive primer and the sealing cover. The first insulation washer is fit on the sealing cover. The hollow conductive terminal is riveted to the first insulation washer and metal washer. The bolt is fastened to the inner threaded portion of the conductive primer via the hollow conductive terminal, first insulation washer, sealing cover, and metal washer and abuts the hollow conductive terminal. A laser welding treatment is applied between the bolt and the hollow conductive terminal, providing a sealing effect therebetween.

The bolt comprises an outer threaded portion engaging the inner threaded portion of the conductive primer.

The battery further comprises at least one second insulation washer disposed between the bolt and the hollow conductive terminal.

Another exemplary embodiment of the invention provides a battery comprising a casing, a electrode plate assembly, at least one conductive primer, at least one sealing cover, at least one metal washer, at least one first insulation washer, at least one hollow conductive terminal, at least one second insulation washer, and at least one bolt. The electrode plate assembly is disposed in the casing and comprises at least one current collection tab. The conductive primer is fit in the current collection tab of the electrode plate assembly and comprises an inner threaded portion. The sealing cover is connected to the casing. The metal washer is disposed between the conductive primer and the sealing cover. The first insulation washer is fit on the sealing cover. The hollow conductive terminal is riveted to the first insulation washer and metal washer. The second insulation washer is disposed on the hollow conductive terminal. The bolt is fastened to the inner threaded portion of the conductive primer via the second insulation washer, hollow conductive terminal, first insulation washer, sealing cover, and metal washer and abuts the second insulation washer. A sealant is applied between the bolt and the hollow conductive terminal, providing a sealing effect therebetween.

The bolt comprises an outer threaded portion engaging the inner threaded portion of the conductive primer.

Yet another exemplary embodiment of the invention provides a battery comprising a casing, a electrode plate assembly, at least one conductive primer, at least one sealing cover, at least one metal washer, at least one first insulation washer, at least one hollow conductive terminal, and at least one rivet. The electrode plate assembly is disposed in the casing and comprises at least one current collection tab. The conductive primer is fit in the current collection tab of the electrode plate assembly. The sealing cover is connected to the casing. The metal washer is disposed between the conductive primer and the sealing cover. The first insulation washer is fit on the sealing cover. The hollow conductive terminal is riveted to the first insulation washer and metal washer. The rivet is connected to the conductive primer via the hollow conductive terminal, first insulation washer, sealing cover, and metal washer and abuts the hollow conductive terminal. A laser welding treatment is applied between the rivet and the hollow conductive terminal, providing a sealing effect therebetween.

The battery further comprises at least one second insulation washer disposed between the rivet and the hollow conductive terminal.

Still another exemplary embodiment of the invention provides a battery comprising a casing, a electrode plate assembly, at least one conductive primer, at least one sealing cover, at least one metal washer, at least one first insulation washer, at least one hollow conductive terminal, at least one second insulation washer, and at least one rivet. The electrode plate assembly is disposed in the casing and comprises at least one current collection tab. The conductive primer is fit in the current collection tab of the electrode plate assembly. The sealing cover is connected to the casing. The metal washer is disposed between the conductive primer and the sealing cover. The first insulation washer is fit on the sealing cover. The hollow conductive terminal is riveted to the first insulation washer and metal washer. The second insulation washer is disposed on the hollow conductive terminal. The rivet is connected to the conductive primer via the second insulation washer, hollow conductive terminal, first insulation washer, sealing cover, and metal washer and abuts the second insulation washer. A sealant is applied between the rivet and the hollow conductive terminal, providing a sealing effect therebetween.

### BRIEF DESCRIPTION OF THE DRAWINGS

The invention can be more fully understood by reading the subsequent detailed description and examples with references made to the accompanying drawings, wherein:

FIG. 1A is a schematic cross section of a conventional rechargeable battery;

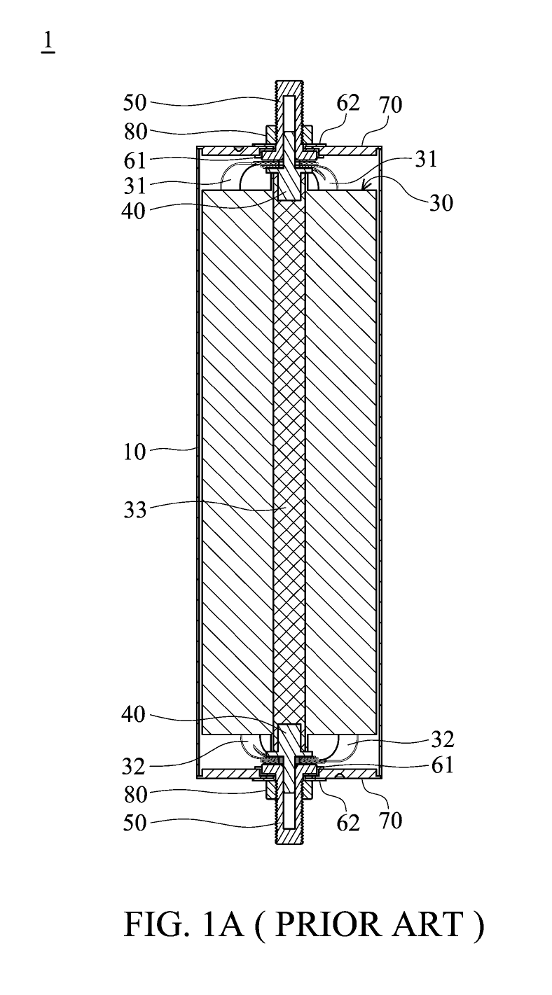

FIG. 1B is a partial exploded view of FIG. 1A;

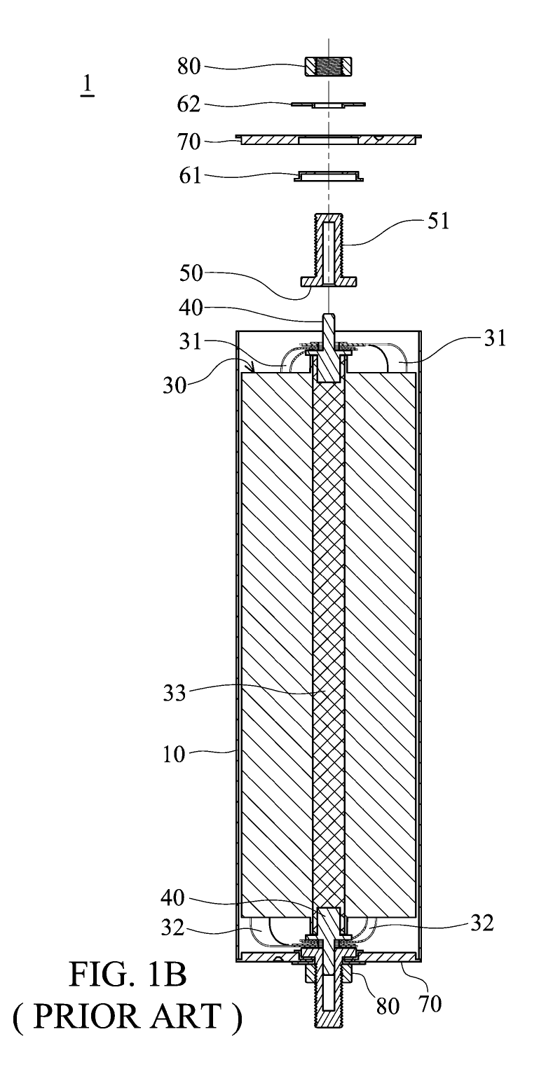

FIG. 2A is a schematic cross section of a battery of a first embodiment of the invention;

FIG. 2B is a partial exploded view of FIG. 2A;

FIG. 3A is a schematic cross section of a battery of a second embodiment of the invention; and

FIG. 3B is a partial exploded view of FIG. 3A.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

### First Embodiment

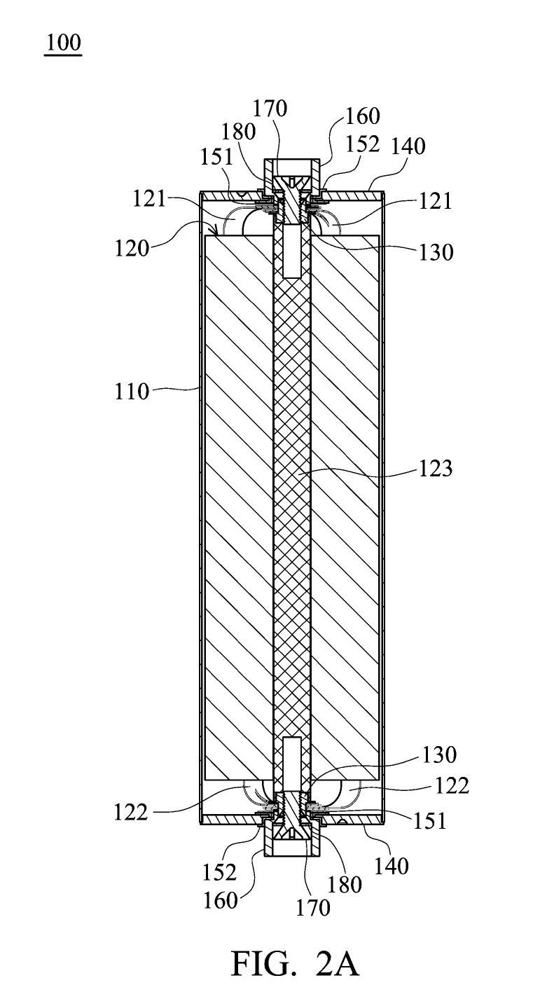

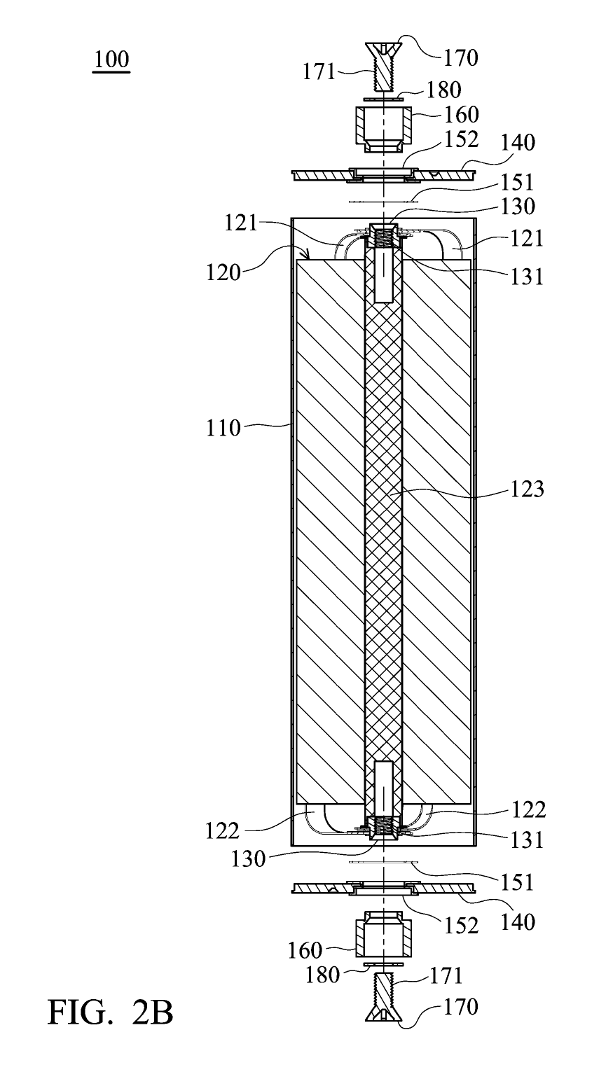

Referring to FIG. 2A and FIG. 2B, a battery 100 may be a rechargeable battery (such as, a lithium battery, a nickel-metal hydride battery, etc.) and comprises a casing 110, a electrode plate assembly 120, two conductive primers 130, two sealing covers 140, two metal washers 151, two first insulation washers 152, two hollow conductive terminals 160, two bolts 170, and two second insulation washers 180.

The electrode plate assembly 120 is disposed in the casing 110 and comprises a positive electrode plate (not shown), a negative electrode plate (not shown), a plurality of separators (not shown), a plurality of positive current collection tabs 121, a plurality of negative current collection tabs 122, and a core 123. Here, the separators are disposed between the positive electrode plate and the negative electrode plate, the positive current collection tabs 121 are connected to the positive electrode plate, and the negative current collection tabs 122 are connected to the negative electrode plate. Additionally, the positive electrode plate, negative electrode plate, and separators are simultaneously wound around the core 123, and the casing 110 is filled with electrolyte (not shown).

The conductive primers 130 are respectively fit in the positive current collection tabs 121 and negative current collection tabs 122. Here, as shown in FIG. 2B, each conductive primer 130 comprises an inner threaded portion 131.

As shown in FIG. 2A and FIG. 2B, the sealing covers 140 are connected to the casing 110. Specifically, the sealing covers 140 respectively surround and connect to the circumferences of two ends of the casing 110.

Each metal washer 151 is disposed between each conductive primer 130 and each sealing cover 140.

Each first insulation washer 152 is fit on each sealing cover 140.

Each hollow conductive terminal 160 is riveted to each first insulation washer 152 and each metal washer 151, such that each hollow conductive terminal 160, each first insulation washer 152, each sealing cover 140, and each metal washer 151 are combined together.

Each bolt 170 is fastened to the inner threaded portion 131 of each conductive primer 130 via each hollow conductive terminal 160, each first insulation washer 152, each sealing cover 140, and each metal washer 151 and abuts each hollow conductive terminal 160. Here, as shown in FIG. 2B, each bolt 170 comprises an outer threaded portion 171 engaging the inner threaded portion 131 of each conductive primer 130, and each second insulation washer 180 is disposed between each bolt 170 and each hollow conductive terminal 160. Specifically, with the second insulation washers 180 employed by this embodiment, a sealant (such as, acrylic glue or epoxy resin) can be applied between each bolt 170 and each hollow conductive terminal 160 after each bolt 170 is fastened to the inner threaded portion 131 of each conductive primer 130 and abuts each hollow conductive terminal 160. Thus, a sealing effect can be provided between each bolt 170 and each hollow conductive terminal 160 without application of a laser welding treatment. Alternatively, when the first insulation washers 152 are employed and the second insulation washers 180 are omitted, the laser welding treatment is applied between each bolt 170 and each hollow conductive terminal 160, providing the sealing effect therebetween. Specifically, the laser welding treatment is applied to an interface between each bolt 170 and each hollow conductive terminal 160, thoroughly sealing seams around the interface. The sealing effect is thus provided between each bolt 170 and each hollow conductive terminal 160.

Moreover, power output of the battery 100 can be achieved using the hollow conductive terminals 160.

Accordingly, in the battery 100 of this embodiment, with the interface between each bolt 170 and each hollow conductive terminal 160 sealed by the laser welding treatment, the electrolyte does not leak out of the casing 110 via the interface. Thus, reliability of the battery 100 can be ensured and potential damage to other devices applying the battery 100 can be prevented. Additionally, as the conductive primers 130, positive current collection tabs 121, negative current collection tabs 122, metal washers 151, hollow conductive terminals 160, and bolts 170 are tightly combined with each other, internal contact impedance of the battery 100 can effectively remain minimal, enabling an optimal power output performance of the battery 100.

### Second Embodiment

Elements corresponding to those in the first embodiment share the same reference numerals.

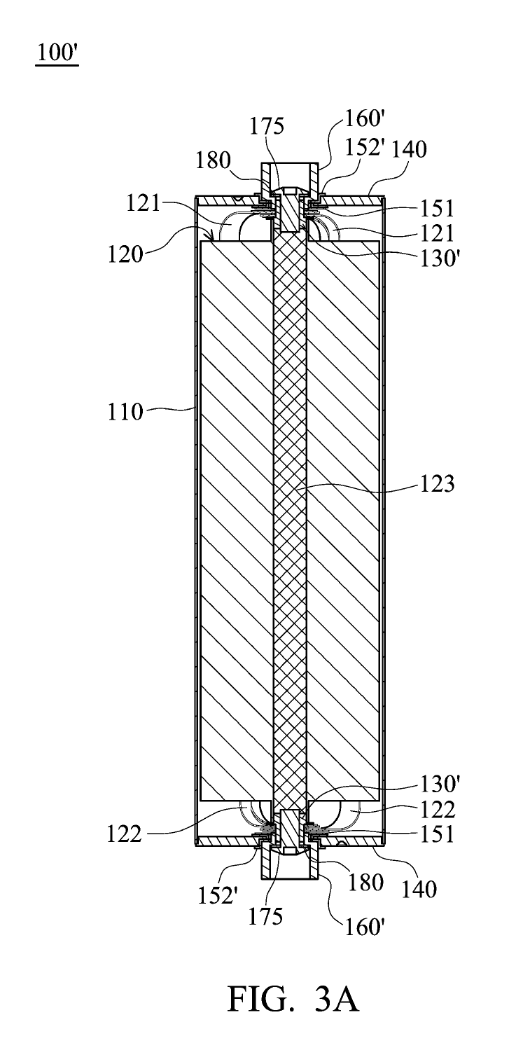

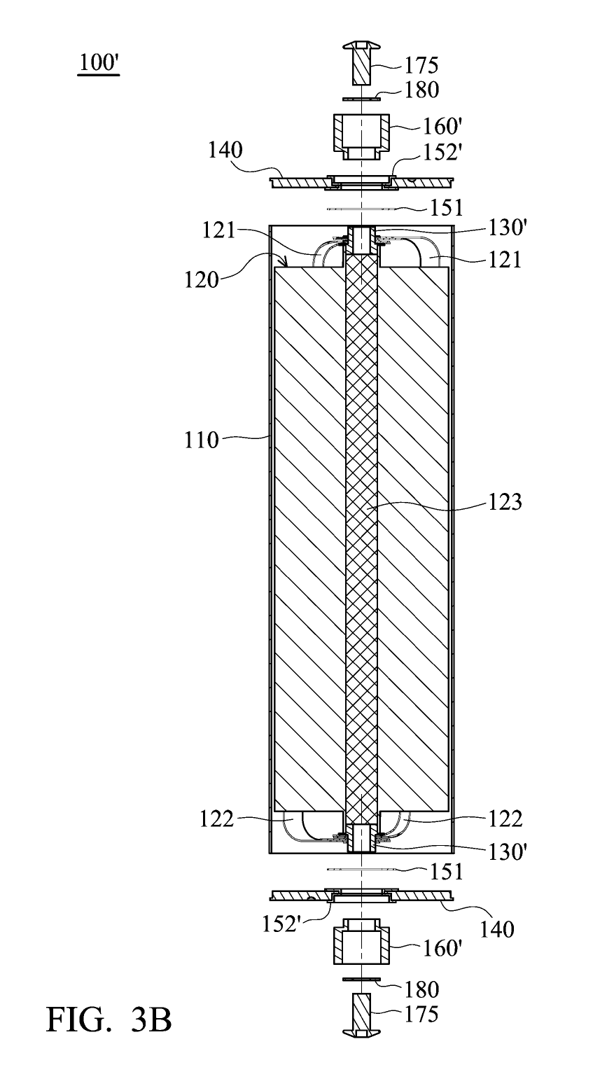

Referring to FIG. 3A and FIG. 3B, a battery 100′ may be a rechargeable battery (such as, a lithium battery, a nickel-metal hydride battery, etc.) and comprises a casing 110, a electrode plate assembly 120, two conductive primers 130′, two sealing covers 140, two metal washers 151, two first insulation washers 152′, two hollow conductive terminals 160′, two rivets 175, and two second insulation washers 180.

Similarly, the electrode plate assembly 120 is disposed in the casing 110 and comprises a positive electrode plate (not shown), a negative electrode plate (not shown), a plurality of separators (not shown), a plurality of positive current collection tabs 121, a plurality of negative current collection tabs 122, and a core 123. Here, the separators are disposed between the positive electrode plate and the negative electrode plate, the positive current collection tabs 121 are connected to the positive electrode plate, and the negative current collection tabs 122 are connected to the negative electrode plate. Additionally, the positive electrode plate, negative electrode plate, and separators are simultaneously wound around the core 123, and the casing 110 is filled with electrolyte (not shown).

The conductive primers 130′ are respectively fit in the positive current collection tabs 121 and negative current collection tabs 122.

The sealing covers 140 are connected to the casing 110. Specifically, the sealing covers 140 respectively surround and connect to the circumferences of two ends of the casing 110.

Each metal washer 151 is disposed between each conductive primer 130′ and each sealing cover 140.

Each first insulation washer 152′ is fit on each sealing cover 140.

Each hollow conductive terminal 160′ is riveted to each first insulation washer 152′ and each metal washer 151, such that each hollow conductive terminal 160′, each first insulation washer 152′, each sealing cover 140, and each metal washer 151 are combined together.

Each rivet 175 is connected to each conductive primer 130′ via each hollow conductive terminal 160′, each first insulation washer 152′, each sealing cover 140, and each metal washer 151 and abuts each hollow conductive terminal 160′. Here, each second insulation washer 180 is disposed between each rivet 175 and each hollow conductive terminal 160′. Specifically, with the second insulation washers 180 employed by this embodiment, a sealant (such as, acrylic glue or epoxy resin) can be applied between each rivet 175 and each hollow conductive terminal 160′ after each rivet 175 is connected to each conductive primer 130′ and abuts each hollow conductive terminal 160′. Thus, a sealing effect can be provided between each rivet 175 and each hollow conductive terminal 160′ without application of a laser welding treatment. Alternatively, when the first insulation washers 152′ are employed and the second insulation washers 180 are omitted, the laser welding treatment is applied between each rivet 175 and each hollow conductive terminal 160′, providing the sealing effect therebetween. Specifically, the laser welding treatment is applied to an interface between each rivet 175 and each hollow conductive terminal 160′, thoroughly sealing seams around the interface. The sealing effect is thus provided between each rivet 175 and each hollow conductive terminal 160′.

Similarly, power output of the battery 100′ can be achieved using the hollow conductive terminals 160′.

Accordingly, in the battery 100′ of this embodiment, with the interface between each rivet 175 and each hollow conductive terminal 160′ sealed by the laser welding treatment, the electrolyte does not leak out of the casing 110 via the interface. Thus, reliability of the battery 100′ can be ensured and potential damage to other devices applying the battery 100′ can be prevented. Additionally, as the conductive primers 130′, positive current collection tabs 121, negative current collection tabs 122, metal washers 151, hollow conductive terminals 160′, and rivets 175 are tightly combined with each other, internal contact impedance of the battery 100′ can effectively remain minimal, enabling an optimal power output performance of the battery 100′.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A battery, comprising:
a casing;
a electrode plate assembly disposed in the casing and comprising at least one current collection tab;
at least one conductive primer fit in the current collection tab of the electrode plate assembly and comprising an inner threaded portion;
at least one sealing cover connected to the casing;
at least one metal washer disposed between the conductive primer and the sealing cover;
at least one first insulation washer fit on the sealing cover;
at least one hollow conductive terminal riveted to the first insulation washer and metal washer; and
at least one bolt fastened to the inner threaded portion of the conductive primer via the hollow conductive terminal, first insulation washer, sealing cover, and metal washer and abutting the hollow conductive terminal, wherein a laser welding treatment is applied between the bolt and the hollow conductive terminal, providing a sealing effect therebetween.

2. The battery as claimed in claim 1, wherein the bolt comprises an outer threaded portion engaging the inner threaded portion of the conductive primer.

3. The battery as claimed in claim 1, further comprising at least one second insulation washer disposed between the bolt and the hollow conductive terminal.

4. A battery, comprising:
a casing;
a electrode plate assembly disposed in the casing and comprising at least one current collection tab;
at least one conductive primer fit in the current collection tab of the electrode plate assembly and comprising an inner threaded portion;
at least one sealing cover connected to the casing;
at least one metal washer disposed between the conductive primer and the sealing cover;
at least one first insulation washer fit on the sealing cover;
at least one hollow conductive terminal riveted to the first insulation washer and metal washer;
at least one second insulation washer disposed on the hollow conductive terminal; and
at least one bolt fastened to the inner threaded portion of the conductive primer via the second insulation washer, hollow conductive terminal, first insulation washer, sealing cover, and metal washer and abutting the second insulation washer, wherein a sealant is applied between the bolt and the hollow conductive terminal, providing a sealing effect therebetween.

5. The battery as claimed in claim 4, wherein the bolt comprises an outer threaded portion engaging the inner threaded portion of the conductive primer.

6. A battery, comprising:
a casing;
a electrode plate assembly disposed in the casing and comprising at least one current collection tab;
at least one conductive primer fit in the current collection tab of the electrode plate assembly;
at least one sealing cover connected to the casing;
at least one metal washer disposed between the conductive primer and the sealing cover;
at least one first insulation washer fit on the sealing cover;
at least one hollow conductive terminal riveted to the first insulation washer and metal washer; and
at least one rivet connected to the conductive primer via the hollow conductive terminal, first insulation washer, sealing cover, and metal washer and abutting the hollow conductive terminal, wherein a laser welding treatment is applied between the rivet and the hollow conductive terminal, providing a sealing effect therebetween.

7. The battery as claimed in claim 6, further comprising at least one second insulation washer disposed between the rivet and the hollow conductive terminal.

8. A battery, comprising:
a casing;
a electrode plate assembly disposed in the casing and comprising at least one current collection tab;
at least one conductive primer fit in the current collection tab of the electrode plate assembly;
at least one sealing cover connected to the casing;
at least one metal washer disposed between the conductive primer and the sealing cover;
at least one first insulation washer fit on the sealing cover;
at least one hollow conductive terminal riveted to the first insulation washer and metal washer;
at least one second insulation washer disposed on the hollow conductive terminal; and
at least one rivet connected to the conductive primer via the second insulation washer, hollow conductive terminal, first insulation washer, sealing cover, and metal washer and abutting the second insulation washer, wherein a sealant is applied between the rivet and the hollow conductive terminal, providing a sealing effect therebetween.
